(19) United States
(12) Patent Application Publication
(10) Pub. No.: US 2023/0035980 A1
(43) Pub. Date: Feb. 2, 2023

(54) Device for Preventing Decrease in Braking Force of Combustion Engine System

(71) Applicants: Hyundai Motor Company, Seoul (KR); Kia Corporation, Seoul (KR)

(72) Inventor: Jae Seok Shin, Hwaseong-si (KR)

(21) Appl. No.: 17/875,602

(22) Filed: Jul. 28, 2022

(30) Foreign Application Priority Data
Jul. 28, 2021 (KR) 10-2021-0099008

(51) Int. Cl. F02D 41/00; F02D 13/02; F02D 13/04; F02B 37/24

(52) U.S. Cl. CPC F02D 41/0077; F02D 41/0057; F02D 13/0223; F02D 13/04; F02B 37/24; F02D 2200/101

(57) ABSTRACT

An embodiment device includes an auxiliary brake including a retarder selectively operated to consume an output of a transmission to generate a braking force and an engine brake selectively operated to increase a flow resistance of an exhaust gas discharged from an engine to generate a braking force, a gas flow volume controller configured to open or close flow paths of an engine intake line and an engine exhaust line, and a controller configured to compare a first braking force difference with a predetermined reference braking force when the auxiliary brake is operated during coasting traveling and to determine and control an opening rate of the gas flow volume controller based on the first braking force difference and an engine speed when the first braking force difference is less than the reference braking force.

### CROSS-REFERENCE TO RELATED APPLICATIONS

This application claims the benefit of Korean Patent Application No. 10-2021-0099008, filed on Jul. 28, 2021, which application is hereby incorporated herein by reference.

### TECHNICAL FIELD

The present disclosure relates to a device for preventing a decrease in a braking force of a combustion engine system.

### BACKGROUND

A vehicle mounted with a diesel engine is provided with a catalytic converter on an engine exhaust line to decrease the discharge of harmful components contained in an engine exhaust gas to the atmosphere.

The catalytic converter is a device configured to oxidize or reduce the harmful components contained in the engine exhaust gas to harmless components using a catalyst to purify them.

To purify the harmful components using the catalytic converter, the temperature of the exhaust gas should be maintained within a proper temperature range. When the temperature of the exhaust gas is not maintained within the proper range and decreases, an amount of harmful materials in the exhaust gas discharged to the atmosphere increases.

Meanwhile, drivers of commercial vehicles, such as large trucks or buses, operate an auxiliary brake for adjusting a traveling speed increased by a weight of the vehicle when releasing an operation of an accelerator pedal and traveling in a coasting state.

As the auxiliary brake, there are an engine brake, a retarder, etc. used in the vehicle mounted with the diesel engine that is operated by 4 strokes of intake, compression, explosion, and exhaust. Further, as the engine brake, there are an exhaust brake and a jake brake.

The commercial vehicle includes an auxiliary braking system in various combinations to increase the auxiliary braking force. For example, the auxiliary braking system may include the retarder and the jake brake or may include the retarder and an exhaust brake.

Since the jake brake and the exhaust brake generate the braking forces by increasing a flowing resistance of the intake and exhaust of an engine, it is possible to secure the required braking force only when the exhaust flow with the high flow volume is generated.

However, if the exhaust flow volume is increased to secure the braking forces of the exhaust brake and the jake brake, a temperature of the exhaust gas decreases. The decrease in the temperature of the exhaust gas results in an increase in the content of the harmful materials in the exhaust gas discharged to the atmosphere.

However, when the exhaust flow volume is decreased to prevent the temperature of the exhaust gas from decreasing upon operations of the exhaust brake and the jake brake, the braking force of the vehicle may not be inevitably prevented from decreasing.

The above information disclosed in this background section is only for enhancement of understanding of the background of the disclosure and accordingly it may include information that does not form the prior art that is already known to a person of ordinary skill in the art.

### SUMMARY

The present disclosure relates to a device for preventing a decrease in a braking force of a combustion engine system. Particular embodiments relate to a device for preventing a decrease in a braking force of a combustion engine system configured to sufficiently secure a braking force generated by an auxiliary brake and to prevent a decrease in a temperature of an exhaust gas caused by securing the braking force of the auxiliary brake.

Embodiments of the present disclosure can problems associated with the related art, and an embodiment of the present disclosure provides a device for preventing a braking force of a combustion engine system from decreasing, which sufficiently secures a braking force generated by an auxiliary brake upon coasting traveling and prevents a decrease in a temperature of an exhaust gas caused by securing the braking force of the auxiliary brake as much as possible.

Therefore, embodiments of the present disclosure provide a device for preventing a decrease in a braking force of a combustion engine system including an auxiliary brake including a retarder selectively operated to consume an output of a transmission to generate a braking force, and an engine brake selectively operated to increase a flow resistance of an exhaust gas discharged from an engine to generate a braking force, a gas flow volume control unit configured to open or close flow paths of an engine intake line and an engine exhaust line, and a control unit configured to compare a first braking force difference, which is a difference between a required braking force requested by a driver from the auxiliary brake and the braking force generated by the retarder, with a predetermined reference braking force when the auxiliary brake is operated during coasting traveling, in which the control unit determines and controls an opening rate of the gas flow volume control unit based on the first braking force difference and an engine speed when the first braking force difference is less than the reference braking force.

According to an exemplary embodiment of the present disclosure, the control unit may compare the engine speed with a predetermined reference speed when the first braking force difference is less than the reference braking force, determine and control the opening rate of the gas flow volume control unit based on the first braking force difference and the engine speed when the engine speed is less than the reference speed, and determine and control the opening rate of the gas flow volume control unit such that a flow volume of intake air of the engine intake line and a flow volume of an exhaust gas of the engine exhaust line are maximized when the engine speed is equal to or more than the reference speed.

Further, the gas flow volume control unit includes an EGR valve configured to open or close a flow path of an exhaust recirculation line that connects the engine exhaust line to the engine intake line, and a part of the exhaust gas discharged to the engine exhaust line flows into the exhaust recirculation line and the engine intake line depending upon an opening rate of the EGR valve.

Further, the gas flow volume control unit includes a turbocharger, and the turbocharger is configured to include a turbine disposed on the engine exhaust line and driven by the exhaust gas, a compressor disposed on the engine intake line and driven in conjunction with the turbine, and configured to compress the intake air flowing into the engine intake line, and a vane provided on the turbine to adjust a flow volume of the exhaust gas supplied to the turbine, in which the flow volume of the exhaust gas flowing into a catalytic converter side disposed on a downstream of the turbine is adjusted depending upon an opening rate of the vane.

Further, the gas flow volume control unit includes an intake valve installed on the engine intake line, and the flow volume of the intake air flowing into the engine intake line is adjusted depending upon an opening rate of the intake valve.

Further, when the first braking force difference is equal to or more than the reference braking force, the control unit controls the opening rate of the EGR valve with a predetermined first opening rate, and controls the opening rate of the intake valve with a predetermined third opening rate while controlling the opening rate of the vane with a predetermined second opening rate.

Further, when the engine speed is equal to or more than the reference speed, if the first braking force difference is less than the reference braking force, the control unit controls the opening rate of the EGR valve with a predetermined first opening rate, and controls the opening rate of the intake valve with a predetermined third opening rate while controlling the opening rate of the vane with a predetermined second opening rate.

Further, the catalytic converter is configured to purify the exhaust gas introduced through the turbine.

According to the above configuration, according to embodiments of the present disclosure, it is possible to sufficiently secure the braking force generated by the auxiliary brake upon coasting traveling, thereby increasing the traveling stability, and to prevent a decrease in a temperature of an exhaust gas caused by securing the braking force of the auxiliary brake as much as possible, thereby decreasing the amount of harmful materials in the exhaust gas discharged to the atmosphere.

It is understood that the term “vehicle” or “vehicular” or other similar term as used herein is inclusive of motor vehicles in general such as passenger automobiles including sport utility vehicles (SUVs), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of embodiments of the disclosure are discussed infra.

### BRIEF DESCRIPTION OF THE DRAWINGS

The above and other features of embodiments of the present disclosure will now be described in detail with reference to certain exemplary examples thereof illustrated in the accompanying drawings which are given herein below by way of illustration only, and thus are not limitative of the present disclosure, and wherein:

FIG. 1 is a diagram illustrating a configuration of a combustion engine system according to embodiments of the present disclosure;

FIG. 2 is a diagram illustrating an auxiliary brake applied to the combustion engine system according to embodiments of the present disclosure;

FIG. 3 is a diagram illustrating a device for preventing a decrease in a braking force of the combustion engine system according to embodiments of the present disclosure; and

FIG. 4 is a diagram illustrating a method for preventing the decrease in the braking force of the combustion engine system according to embodiments of the present disclosure.

It should be understood that the appended drawings are not necessarily to scale, presenting a somewhat simplified representation of various features illustrative of the basic principles of embodiments of the disclosure. The specific design features of embodiments of the present disclosure as disclosed herein, including, for example, specific dimensions, orientations, locations, and shapes will be determined in part by the particular intended application and use environment.

In the figures, reference numbers refer to the same or equivalent sections of embodiments of the present disclosure throughout the several figures of the drawings.

### DETAILED DESCRIPTION OF ILLUSTRATIVE EMBODIMENTS

Hereinafter, exemplary embodiments of the present disclosure will be described with reference to the accompanying drawings. The contents illustrated in the accompanying drawings are schematized to easily explain the exemplary embodiments of the present disclosure and may be different from the form actually implemented.

Throughout the specification, when a certain portion “comprises” a certain component, it means that other components may be further included, rather than excluding other components, unless otherwise stated especially.

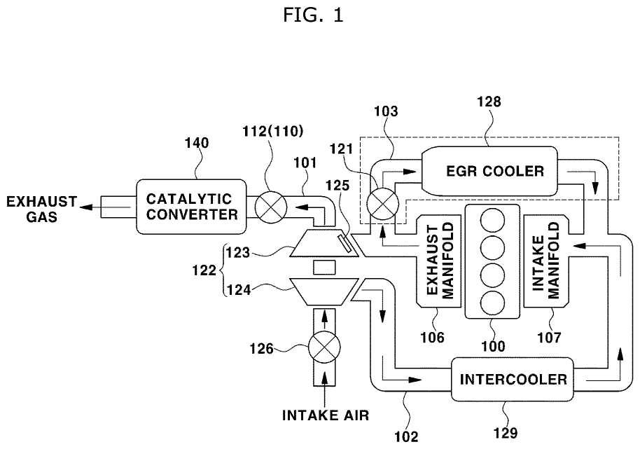

As illustrated in FIGS. 1 to 3, a combustion engine system according to embodiments of the present disclosure is configured to include a diesel engine 100, an auxiliary brake 110, and a gas flow volume control unit 120.

The diesel engine 100 discharges an exhaust gas generated when fuel is combusted to an engine exhaust line 101 through an exhaust manifold 106, and a catalytic converter 140 is disposed and provided on the engine exhaust line 101 to purify harmful materials, such as nitrogen oxide (NOₓ), contained in the exhaust gas.

The catalytic converter 140 is disposed on the downstream of a turbine 123 provided in a turbocharger 122 with respect to a flow direction of the exhaust gas and is configured to purify the exhaust gas supplied through the turbine 123. The catalytic converter 140 is also referred to as a selective catalyst reduction (SCR) device.

The auxiliary brake 110 is a braking device provided in the vehicle separately from a service brake configured to directly provide a braking force to a vehicle wheel 105. The auxiliary brake 110 may be configured in various combinations to increase the braking force. The vehicle may be a commercial vehicle.

Specifically, the auxiliary brake no may be configured to include an engine brake 111 provided in an engine exhaust system, etc. and a retarder 114 provided in an engine power delivery system. The engine brake 111 may be configured to include at least one of an exhaust brake 112 and a fake brake 113.

The exhaust brake 112 is a device that is provided on the engine exhaust line 101 to be selectively operated to increase the flow resistance of the exhaust gas discharged from the diesel engine 100 to generate the braking force. The exhaust brake 112 may be an exhaust valve configured to open or close a gas flow path of the engine exhaust line 101.

For example, the exhaust brake 112 may generate the braking force by forcibly closing the exhaust valve after an explosion stroke of the diesel engine 100 occurs to disturb the flow of the exhaust gas discharged from the diesel engine 100.

As in the exhaust brake 112, the jake brake 113 is a device that is selectively operated to increase the flow resistance of the exhaust gas to generate the braking force. At this time, the jake brake 113 may be a valve provided in the diesel engine 100 other than the engine exhaust line 101.

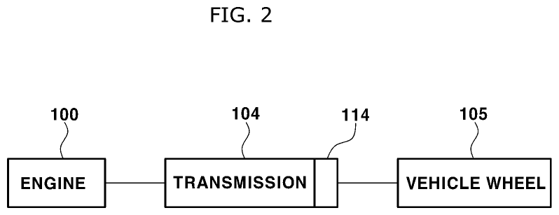

As illustrated in FIG. 2, the retarder 114 is a device that is mounted on a transmission 104 to be selectively operated to consume an output of the transmission 104 to generate the braking force. The transmission 104 is a device configured to convert a power generated by the diesel engine 100 into a required rotation force depending upon a speed to deliver the rotation force to the vehicle wheel 105 side.

The retarder 114 may be a fluid clutch including a rotor connected to an output shaft of the transmission 104 to be rotated and a stator disposed outside the rotor. The rotor is configured to be rotated with the output shaft of the transmission 104, and operation fluid is selectively supplied to a space between the rotor and the stator. If the rotor is rotated in the operation fluid, a rotation resistance is generated by a viscosity resistance of the fluid, thereby consuming the output of the transmission 104. In other words, the retarder 114 is a device configured to consume the output of the transmission 104 as the rotor rotates within the operation fluid. The retarder 114 generates the braking force by consuming the output of the transmission 104 to eventually lose the power of the diesel engine 100.

The retarder 114 may be normally provided with a sensor configured to detect the closeness between the rotor and the stator. A signal detected by the sensor of the retarder 114 may be transmitted to the control unit 130, and the control unit 130 may be configured to calculate the braking force generated by the retarder 114 based on the signal transmitted by the sensor provided on the retarder 114.

The retarder 114 generates the heat as the rotor is rotated within the operation fluid to consume the output of the transmission 104, and when an amount of the generated heat is equal to or more than a limited amount of the heat, the braking force is decreased. Therefore, if the retarder 114 is driven for a long time, it is possible to initially satisfy a required braking force of a driver but when the amount of the generated heat of the retarder 114 reaches the limit amount of the heat after a certain time elapses, the braking force not reaching the required braking force of the driver is generated.

The control unit 130 may be a control unit that is previously provided in the vehicle. Further, the control unit 130 may also include two or more control units provided in the vehicle.

The auxiliary brake 110 may be operated by operating an operation lever 115 provided in a vehicle interior. When the driver operates the auxiliary brake 110 by operating the operation lever 115, the engine brake in and the retarder 114 are operated together to generate the braking forces.

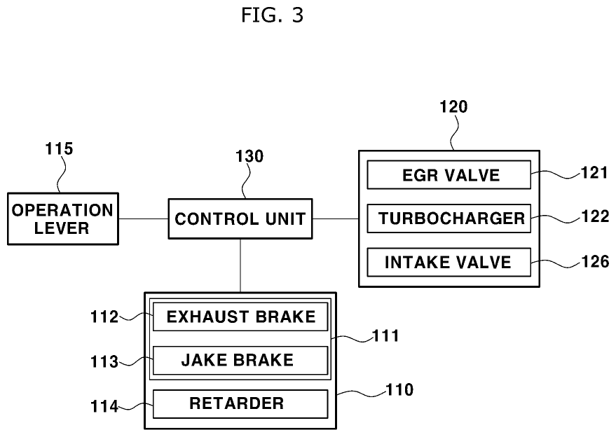

The gas flow volume control unit 120 is a device configured to open or close a gas flow path of an engine intake line 102 and the gas flow path of the engine exhaust line 101. As illustrated in FIG. 3, the gas flow volume control unit 120 includes an exhaust gas recirculation (EGR) valve 121, the turbocharger 122, and an intake valve 126.

The EGR valve 121 is configured to open or close the flow path of an exhaust recirculation line 103. The exhaust recirculation line 103 is a gas flow line that connects the engine exhaust line 101 to the engine intake line 102. Referring to FIG. 1, the exhaust recirculation line 103 is configured to connect a downstream of the exhaust manifold 106 to an upstream of an intake manifold 107.

When operated to open the flow path of the exhaust recirculation line 103, the EGR valve 121 may flow a part of the exhaust gas discharged by the diesel engine 100 toward an upstream of the turbocharger 122 into the exhaust recirculation line 103. Therefore, the flow volume of the exhaust gas flowing into the engine intake line 102 through the exhaust recirculation line 103 may be determined depending upon an opening rate of the EGR valve 121.

The EGR valve 121 may be driven depending upon an opening rate determined by the control unit 130. A part of the exhaust gas discharged by the diesel engine 100 to the engine exhaust line 101 may flow into the exhaust recirculation line 103 depending upon the opening rate of the EGR valve 121, and flow back to the diesel engine 100 through the engine intake line 102.

For example, if the opening rate of the EGR valve 121 is 0%, the exhaust gas may not flow into the engine intake line 102. If the opening rate of the EGR valve 121 exceeds 0%, the exhaust gas may flow into the exhaust recirculation line 103 and flow into the engine intake line 102 through the exhaust recirculation line 103. As the opening rate of the EGR valve 121 increases, the flow volumes of the exhaust gases flowing into the exhaust recirculation line 103 and the engine intake line 102 may increase.

The control unit 130 may control the opening rate of the EGR valve 121 based on a first braking force difference from the engine speed. To this end, an EGR valve opening rate determination map configured to determine the opening rate of the EGR valve 121 based on the first braking force difference from the engine speed may be previously configured and stored in the control unit 130. The first braking force difference is a difference value between the required braking force of the driver and the braking force of the retarder 114.

As illustrated in FIG. 1, the turbocharger 122 may be configured to include the turbine 123, a compressor 124, and a vane 125. Here, the turbocharger 122 is a variable geometry turbocharger (VGT) configured to variably control the opening rate of the vane 125.

The turbine 123 is disposed on the engine exhaust line 101 and configured to be driven by the exhaust gas flowing into the engine exhaust line 101. The turbine 123 is configured to be rotated by a flow energy of the exhaust gas.

The compressor 124 is disposed on the engine intake line 102 and is configured to be rotated with the turbine 123. The compressor 124 is coaxially connected to the turbine 123 to be integrally rotated. The compressor 124 is configured to be driven in conjunction with the turbine 123 to compress the intake air flowing into the engine intake line 102.

The vane 125 is provided on the turbine 123 and is configured to adjust the flow volume of the exhaust gas supplied to the turbine 123. The flow volume of the exhaust gas supplied to the turbine 123 may be controlled by adjusting the opening rate of the vane 125. The opening rate of the vane 125 may be adjusted by an actuator whose operation is controlled by the control unit 130.

When the opening rate of the vane 125 is increased, the flow volume of the exhaust gas flowing into the turbine 123 increases, and when the opening rate of the vane 125 is decreased, the flow volume of the exhaust gas flowing into the turbine 123 decreases. At this time, the exhaust gas flowing into the turbine 123 rotates and passes through the turbine 123 and then flows into the exhaust brake 112 and the catalytic converter 140 sides.

In other words, as the opening rate of the vane 125 increases, the flow volume of the exhaust gas rotating and passing through the turbine 123 and flowing into the catalytic converter 140 side increases, and as the opening rate of the vane 125 decreases, the flow volume of the exhaust gas rotating and passing through the turbine 123 and flowing into the exhaust brake 112 and the catalytic converter 140 sides decreases.

Further, when the flow volume of the exhaust gas flowing into the turbine 123 increases, an intake boost pressure by the compressor 124 is increased, and when the flow volume of the exhaust gas flowing into the turbine 123 decreases, the intake boost pressure by the compressor 124 is decreased.

The control unit 130 may control the opening rate of the vane 125 based on the engine speed and the first braking force difference. To this end, a vane opening rate determination map configured to determine the opening rate of the vane 125 based on the engine speed and the first braking force difference may be previously configured and stored in the control unit 130.

The intake valve 126 is a device that is installed on the engine intake line 102 to open or close the gas flow path of the engine intake line 102. The intake valve 126 may be disposed on an upstream of the compressor 124.

The intake valve 126 is operated depending upon the opening rate determined by the control unit 130, and the flow volume of the intake air flowing into the engine intake line 102 is adjusted depending upon the opening rate of the intake valve 126. Specifically, the flow volume of the intake air flowing into the engine intake line 102 is adjusted depending upon the opening rate of the intake valve 126 and the opening rate of the vane 125.

The control unit 130 may control the opening rate of the intake valve 126 based on the engine speed and the first braking force difference. To this end, an intake valve opening rate determination map configured to determine the opening rate of the intake valve 126 based on the engine speed and the first braking force difference may be previously configured and stored in the control unit 130.

Referring to FIG. 3, the control unit 130 is configured to receive a signal (operation signal) of the operation lever 115 for starting to operate the auxiliary brake 110.

The operation lever 115 is an operation part configured to operate the auxiliary brake 110. The operation lever 115 generates the operation signal by the driver's operation, and the control unit 130 operates the auxiliary brake no when receiving the operation signal.

Further, the control unit 130 is configured to determine the required braking force of the driver for the auxiliary brake no based on the operation signal when receiving the operation signal. The required braking force is a braking force expected and requested by the driver from the auxiliary brake 110.

Specifically, the control unit 130 stores the required braking force of the driver as a predetermined auxiliary braking force value, and the control unit 130 determines the auxiliary braking force value as the required braking force value of the driver when receiving the operation signal of the operation lever 115.

Meanwhile, the control unit 130 operates the auxiliary brake no and controls the operation of the gas flow volume control unit 120 when receiving the operation signal of the operation lever 115 during coasting traveling. Further, the control unit 130 simultaneously operates the retarder 114 and the engine brake in when the operation of the auxiliary brake 110 is required.

Further, FIG. 1 illustrates an EGR cooler 128 and an intercooler 129. The EGR cooler 128 is a device configured to cool the exhaust gas flowing into the exhaust recirculation line 103 through the EGR valve 121. The intercooler 129 is a device configured to cool the intake air compressed by the compressor 124.

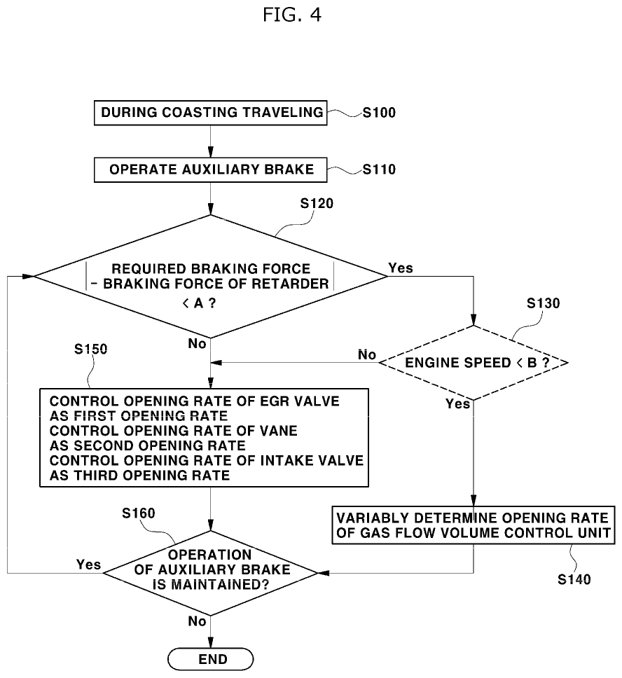

Hereinafter, a method for controlling the gas flow volume control unit 120 upon operation of the auxiliary brake no will be described with reference to FIG. 4.

As illustrated in FIG. 4, the control unit 130 operates the auxiliary brake 110 when the driver operates the operation lever 115 during coasting traveling of the vehicle (S100, S110).

When the driver travels in a coasting state without depressing the accelerator pedal and a braking pedal, the engine 100 enters an idling state.

When the auxiliary brake 110 is operated and the braking force of the retarder 114 and the braking force of the engine brake 111 are generated, the control unit 130 compares a difference (i.e., the first braking force difference) between the required braking force of the driver and the braking force of the retarder 114 with a reference braking force A (S120).

The braking force of the retarder 114 is a braking force actually generated by the driving of the retarder 114. For example, the braking force of the retarder 114 may vary depending upon the speed of the vehicle and the temperature of coolant for cooling the retarder 114.

The reference braking force A may be set as a braking force value of a certain rate with respect to the required braking force. For example, the reference braking force A may be set as a braking force value that is 50% of the required braking force, or a braking force value that is smaller than 50% of the required braking force. At this time, the value of the reference braking force A may be stored in the control unit 130.

As a comparison result in step S120, when the first braking force difference is less than the reference braking force A, the control unit 130 may immediately enter step S140 to determine and control the opening rate of the gas flow volume control unit 120 based on the first braking force difference and the engine speed (S140).

If the first braking force difference is less than the reference braking force A, it may be determined that the braking force of the retarder 114 has been generated as much as possible. Since the braking force of the retarder 114 is greater than the braking force of the engine brake 111, it is possible to secure the required braking force of the driver at a certain rate or more even if the braking force of the engine brake 111 is not secured as much as possible if the braking force of the retarder 114 is generated as much as possible. As a result, it is not necessary to increase the flow volume of the exhaust gas as much as possible.

Therefore, when the first braking force difference is less than the reference braking force A, the control unit 130 may determine and control the opening rate of the gas flow volume control unit 120 depending upon the stored opening rate determination map, thereby optimizing the flow volume of the exhaust gas supplied toward the catalytic converter 140.

At this time, the opening rate determination map includes the EGR valve opening rate determination map, the vane opening rate determination map, and the intake valve opening rate determination map, and each opening rate determination map is configured to optimize and determine the flow volume of the exhaust gas to maintain the performance of the catalytic converter 140.

Generally, if the flow volume of the exhaust gas flowing from the engine exhaust line 101 toward the catalytic converter 140 increases, the temperature of the exhaust gas relatively decreases.

Therefore, the control unit 130 determines and controls the opening rate of the gas flow volume control unit 120 through the opening rate determination map to generate the braking force of the engine brake 111 within a range of maintaining the performance of the catalytic converter 140.

Since the catalytic converter 140 is a device configured to purify the harmful components in the exhaust gas using catalysts, the temperature of the exhaust gas should be maintained within a proper range to secure the performance of the catalytic converter 140.

Further, since the engine brake 111 generates the braking force using the flow resistance of the exhaust gas, the relatively smaller braking force is generated in a low-speed driving region of the engine 100, and the relatively larger braking force is generated in a high-speed driving region of the engine 100.

The operation property of the engine brake 111 is the item also recognized by the driver, and the driver expects the braking force of the engine brake 111 to be normally generated when operating the operation lever 115 in the high-speed driving region of the engine 100.

Therefore, it is necessary to minimize the loss of the braking force due to the decrease in the flow volume of the exhaust gas in the high-speed driving region of the engine 100 and to secure the braking force of the engine brake 111.

Therefore, the control unit 130 may enter step S130 before entering step S140 to compare the engine speed with a reference speed B (S130). In other words, the control unit 130 may execute step S120 followed by step Si30. At this time, the reference speed B may be set as a speed value that distinguishes the low-speed driving region and the high-speed driving region of the engine 100. For example, the reference speed B may be 1,500 rpm.

As a comparison result in step S130, when the engine speed is less than the reference speed B, that is, when the engine 100 is being rotated at low speed, the control unit 130 may enter step S140 to variably operate the gas flow volume control unit 120 depending upon the opening rate determined by the opening rate determination map of the control unit 130 (S140).

The opening rate determination map determines the opening rate of the gas flow volume control unit 120 based on a real-time engine speed and the first braking force difference. Therefore, in step S140, when the opening rate of the gas flow volume control unit 120 is determined and controlled by the opening rate determination map, the temperature of the exhaust gas flowing into the catalytic converter 140 side is appropriately maintained while the flow volumes of the exhaust gas and the intake air are optimized. As the temperature of the exhaust gas is appropriately maintained, it is possible to prevent a decrease in the performance of the catalytic converter 140 due to a decrease in the temperature of the exhaust gas, and eventually, to normally maintain the performance of the catalytic converter 140.

Further, following step S140, the control unit 130 may determine whether the operation of the auxiliary brake no needs to be maintained based on the signal of the operation lever 115 (S160). If the auxiliary brake no is continuously operated, the control unit 130 may execute step S120 again, and if the operation of the auxiliary brake no is released, the control unit 130 may allow the vehicle to enter a re-acceleration mode depending upon the driver's request.

At this time, since the performance of the catalytic converter 140 is maintained even if the vehicle enters the re-acceleration mode, the content of the harmful components in the exhaust gas discharged to the atmosphere may be maintained at a proper value or less.

Meanwhile, as a comparison result in step S130, if the engine speed is the reference speed B or more, that is, if the engine 100 is being rotated at high speed, it is necessary to secure the braking force of the engine brake 111 as much as possible.

Therefore, to secure the maximum braking force of the engine brake 111, the control unit 130 determines and controls the opening rate of the gas flow volume control unit 120 such that the flow volume of the intake air of the engine intake line 102 and the flow volume of the exhaust gas of the engine exhaust line 101 are maximized.

At this time, to increase or maximize the flow volume of the exhaust gas of the engine exhaust line 101, the control unit 130 controls the opening rate (%) of the EGR valve 121 with a predetermined first opening rate, thereby minimizing or blocking the introduction of the exhaust gas into the exhaust recirculation line 103, and controls the opening rate of the intake valve 126 with a predetermined third opening rate while controlling the opening rate of the vane 125 provided on the turbocharger 122 with a predetermined second opening rate (S150), thereby increasing the flow volume of the exhaust gas flowing into the catalytic converter 140 side and the flow volume of the intake air flowing into the intake line 102 as much as possible.

Here, the first opening rate may be set as a value of the opening rate of the EGR valve 121 at which the introduction of the exhaust gas into the exhaust recirculation line 103 may be minimized or blocked, and for example, set as a value of 0% to 2%. Further, the second opening rate may be set as a value of the opening rate of the vane 125 at which the flow volume of the exhaust gas flowing into the catalytic converter 140 side may be increased as much as possible, and for example, set as a value of 30% to 100%. Further, the third opening rate may be set as a value of the opening rate of the intake valve 126 at which the flow volume of the intake air flowing into the engine intake line 102 may be increased as much as possible, and for example, set as a value of 80% to 100%.

In this case, as the temperature of the exhaust gas is decreased, the performance of the catalytic converter 140 may be decreased, but it is possible to sufficiently secure the braking force of the auxiliary brake no, thereby securing the traveling stability of the vehicle.

Further, as a comparison result in step S120, to secure the braking force of the engine brake 111 as much as possible even when the first braking force difference is equal to or more than the reference braking force A, the control unit 130 controls the opening rate of the EGR valve 121 with the predetermined first opening rate and controls the opening rate of the intake valve 126 with the predetermined third opening rate while controlling the opening rate of the vane 125 with the predetermined second opening rate (S150).

As described above, the exemplary embodiments of the present disclosure have been described in detail, and the terms or words used in the present specification and claims should not be construed as being limited to conventional or dictionary meanings, and further, the exemplary embodiments described in the present specification and the configurations illustrated in the drawings are merely exemplary embodiments of the present disclosure, and therefore, the scope of the present disclosure is not limited to the aforementioned exemplary embodiments, and various modifications and improvements made by those skilled in the art using the basic concept of the present disclosure defined in the appended claims are also included in the scope of the present disclosure.

What is claimed is:

1. A device for preventing a decrease in a braking force of a combustion engine system, the device comprising:
an auxiliary brake comprising a retarder configured to be selectively operated to consume an output of a transmission to generate a first braking force and an engine brake configured to be selectively operated to increase a flow resistance of an exhaust gas discharged from an engine to generate a second braking force;
a gas flow volume controller configured to open or close flow paths of an engine intake line and an engine exhaust line; and
a controller configured to:
compare a first braking force difference between a required braking force requested by a driver from the auxiliary brake and the braking force generated by the retarder with a predetermined reference braking force when the auxiliary brake is operated during coasting traveling; and
determine and control an opening rate of the gas flow volume controller based on the first braking force difference and an engine speed when the first braking force difference is less than the reference braking force.

2. The device of claim 1, wherein the controller is configured to:
compare the engine speed with a predetermined reference speed when the first braking force difference is less than the reference braking force;
determine and control the opening rate of the gas flow volume controller based on the first braking force difference and the engine speed when the engine speed is less than the reference speed; and
determine and control the opening rate of the gas flow volume controller such that a flow volume of intake air of the engine intake line and a flow volume of an exhaust gas of the engine exhaust line are maximized when the engine speed is greater than or equal to the reference speed.

3. The device of claim 2, wherein the gas flow volume controller comprises an EGR valve configured to open or close a flow path of an exhaust recirculation line connecting the engine exhaust line to the engine intake line, and wherein a part of the exhaust gas discharged to the engine exhaust line that flows into the exhaust recirculation line and the engine intake line is adjusted according to an opening rate of the EGR valve.

4. The device of claim 3, wherein the gas flow volume controller comprises a turbocharger, the turbocharger comprising:
a turbine disposed on the engine exhaust line and configured to be driven by the exhaust gas;
a compressor disposed on the engine intake line and configured to be driven in conjunction with the turbine and configured to compress the intake air flowing into the engine intake line; and
a vane provided on the turbine and configured to adjust a flow volume of the exhaust gas supplied to the turbine, wherein the flow volume of the exhaust gas flowing into a catalytic converter side disposed on a downstream of the turbine is adjusted according to an opening rate of the vane.

5. The device of claim 4, wherein the gas flow volume controller comprises an intake valve installed on the engine intake line, and wherein the flow volume of the intake air flowing into the engine intake line is adjusted according to an opening rate of the intake valve.

6. The device of claim 5, wherein when the first braking force difference is greater than or equal to the reference braking force, the controller is configured to control the opening rate of the EGR valve with a predetermined first opening rate and to control the opening rate of the intake valve with a predetermined third opening rate while controlling the opening rate of the vane with a predetermined second opening rate.

7. The device of claim 5, wherein when the engine speed is greater than or equal to the reference speed and when the first braking force difference is less than the reference braking force, the controller is configured to control the opening rate of the EGR valve with a predetermined first opening rate and to control the opening rate of the intake valve with a predetermined third opening rate while controlling the opening rate of the vane with a predetermined second opening rate.

8. The device of claim 4, further comprising a catalytic converter configured to purify the exhaust gas introduced through the turbine.

9. A vehicle comprising:
an engine;
a transmission;
a service brake;
a vehicle wheel configured to receive a first braking force directly from the service brake;
an auxiliary brake comprising:
a retarder mounted on the transmission and configured to be selectively operated to consume an output of the transmission to generate a second braking force; and
an engine brake configured to be selectively operated to increase a flow resistance of an exhaust gas discharged from the engine to generate a third braking force;
a gas flow volume controller configured to open or close flow paths of an engine intake line and an engine exhaust line; and
a controller configured to:
compare a first braking force difference between a required braking force requested by a driver from the auxiliary brake and the braking force generated by the retarder with a predetermined reference braking force when the auxiliary brake is operated during coasting traveling; and
determine and control an opening rate of the gas flow volume controller based on the first braking force difference and an engine speed when the first braking force difference is less than the reference braking force.

10. The vehicle of claim 9, wherein the controller is configured to:
compare the engine speed with a predetermined reference speed when the first braking force difference is less than the reference braking force;
determine and control the opening rate of the gas flow volume controller based on the first braking force difference and the engine speed when the engine speed is less than the reference speed; and
determine and control the opening rate of the gas flow volume controller such that a flow volume of intake air of the engine intake line and a flow volume of an exhaust gas of the engine exhaust line are maximized when the engine speed is greater than or equal to the reference speed. ii. The vehicle of claim 10, wherein the gas flow volume controller comprises an EGR valve configured to open or close a flow path of an exhaust recirculation line connecting the engine exhaust line to the engine intake line, and wherein a part of the exhaust gas discharged to the engine exhaust line that flows into the exhaust recirculation line and the engine intake line is adjusted according to an opening rate of the EGR valve.

12. The vehicle of claim ii, wherein the gas flow volume controller comprises a turbocharger, the turbocharger comprising:
a turbine disposed on the engine exhaust line and configured to be driven by the exhaust gas;
a compressor disposed on the engine intake line and configured to be driven in conjunction with the turbine and configured to compress the intake air flowing into the engine intake line; and
a vane provided on the turbine and configured to adjust a flow volume of the exhaust gas supplied to the turbine, wherein the flow volume of the exhaust gas flowing into a catalytic converter side disposed on a downstream of the turbine is adjusted according to an opening rate of the vane.

13. The vehicle of claim 12, wherein the gas flow volume controller comprises an intake valve installed on the engine intake line, and wherein the flow volume of the intake air flowing into the engine intake line is adjusted according to an opening rate of the intake valve.

14. The vehicle of claim 13, wherein when the first braking force difference is greater than or equal to the reference braking force, the controller is configured to control the opening rate of the EGR valve with a predetermined first opening rate and to control the opening rate of the intake valve with a predetermined third opening rate while controlling the opening rate of the vane with a predetermined second opening rate.

15. The vehicle of claim 13, wherein when the engine speed is greater than or equal to the reference speed and when the first braking force difference is less than the reference braking force, the controller is configured to control the opening rate of the EGR valve with a predetermined first opening rate and to control the opening rate of the intake valve with a predetermined third opening rate while controlling the opening rate of the vane with a predetermined second opening rate.

16. The vehicle of claim 12, further comprising a catalytic converter configured to purify the exhaust gas introduced through the turbine.

17. A method for controlling a gas flow volume controller during operation of an auxiliary brake during coasting traveling of a vehicle, the method comprising:
comparing a first braking force difference between a required braking force requested by a driver from the auxiliary brake and a braking force generated by a retarder with a predetermined reference braking force; and
determining and controlling an opening rate of the gas flow volume controller based on the first braking force difference and an engine speed when the first braking force difference is less than the reference braking force.

18. The method of claim 17, further comprising:
comparing the engine speed with a predetermined reference speed when the first braking force difference is less than the reference braking force;
determining and controlling the opening rate of the gas flow volume controller based on the first braking force difference and the engine speed when the engine speed is less than the reference speed; and
determining and controlling the opening rate of the gas flow volume controller such that a flow volume of intake air of an engine intake line and a flow volume of an exhaust gas of an engine exhaust line are maximized when the engine speed is greater than or equal to the reference speed.

19. The method of claim 18, wherein the gas flow volume controller comprises:
an EGR valve that opens or closes a flow path of an exhaust recirculation line connecting the engine exhaust line to the engine intake line, wherein a part of the exhaust gas discharged to the engine exhaust line that flows into the exhaust recirculation line and the engine intake line is adjusted according to an opening rate of the EGR valve;
a turbocharger comprising:
a turbine disposed on the engine exhaust line and driven by the exhaust gas;
a compressor disposed on the engine intake line and driven in conjunction with the turbine, wherein the compressor compresses the intake air flowing into the engine intake line; and
a vane provided on the turbine that adjusts a flow volume of the exhaust gas supplied to the turbine, wherein the flow volume of the exhaust gas flowing into a catalytic converter side disposed on a downstream of the turbine is adjusted according to an opening rate of the vane; and
an intake valve installed on the engine intake line, wherein the flow volume of the intake air flowing into the engine intake line is adjusted according to an opening rate of the intake valve.

20. The method of claim 19, wherein:
when the first braking force difference is greater than or equal to the reference braking force, the method further comprises controlling the opening rate of the EGR valve with a predetermined first opening rate and controlling the opening rate of the intake valve with a predetermined third opening rate while controlling the opening rate of the vane with a predetermined second opening rate; and
when the engine speed is greater than or equal to the reference speed and when the first braking force difference is less than the reference braking force, the method further comprises controlling the opening rate of the EGR valve with the predetermined first opening rate and controlling the opening rate of the intake valve with the predetermined third opening rate while controlling the opening rate of the vane with the predetermined second opening rate.
